(19) United States
(12) Patent Application Publication
(10) Pub. No.: US 2024/0323335 A1
(43) Pub. Date: Sep. 26, 2024

(54) LIGHT CAPTURE DEVICE AND LIGHT CAPTURE SYSTEM INCLUDING SAME

(71) Applicant: LG ELECTRONICS INC., Seoul (KR)

(72) Inventor: Chanyong PARK, Seoul (KR)

(73) Assignee: LG ELECTRONICS INC., Seoul (KR)

(21) Appl. No.: 18/698,197

(22) PCT Filed: Aug. 17, 2022
(86) PCT No.: PCT/KR2022/012224

§ 371 Date: Apr. 3, 2024

(30) Foreign Application Priority Data
Oct. 5, 2021 (KR) 10-2021-0131429

(51) Int. Cl. H04N 13/156; G06T 15/06; H04N 13/15; H04N 23/54; H04N 23/55

(52) U.S. Cl. CPC H04N 13/156; G06T 15/06; H04N 13/15; H04N 23/54; H04N 23/55

(57) ABSTRACT

A light capture device and a light capture system including the same are disclosed. The light capture device according to an embodiment of the present disclosure comprises: a case; a plurality of lens devices arranged in the case and including two lens devices facing each other; an image sensor for converting light that has passed through the plurality of lens devices into an electrical signal; and a processor for signal-processing a plurality of images output from the image sensor, wherein the processor is configured to output light information including the intensity of the light, the color of the light, and the direction information of the light in the plurality of images. Accordingly, it is possible to output light information in all directions.

### BACKGROUND

### 1. Technical Field

The present disclosure relates to a light capture device and a light capture system including the same, and more particularly, to a light capture device capable of outputting light information in all directions and a light capture system including the same.

### 2. Description of the Related Art

A camera device is a device for photographing an image.

Meanwhile, in a case where a camera device is used when shooting a movie, when a blue screen photographing of a person in a studio is synthesized with a background image, there will be differences from the actual scene image depending on the difference in light, such as lighting.

Therefore, when synthesizing a background image and a person image, it is important to utilize light information.

### SUMMARY

An object of the present disclosure is to provide a light capture device capable of outputting light information in all directions and a light capture system including the same.

Another object of the present disclosure is to provide a light capture system capable of synthesizing an image close to a live action image based on light information in all directions and photographed images.

In an aspect, there are provided an optical capture device and an optical capture system including the same comprising a case; a plurality of lens devices disposed in the case, and including two lens devices facing each other; an image sensor configured to convert light that passed through the plurality of lens devices into an electrical signal; and a processor configured to process a plurality of images output from the image sensor, wherein the processor is configured to output light information including light intensity, light color, and light direction information in the plurality of images.

Meanwhile, the processor may be configured to add the light information to each of the plurality of images and output the plurality of images added to the light information.

Meanwhile, the processor may be configured to output an image corresponding to the number of the plurality of lens devices, and the light information including the light intensity, the light color, and the light direction information in the plurality of images.

Meanwhile, the processor may be configured to output the light information by differentiating a format of the plurality of images and a format of the light information.

Meanwhile, the processor may be configured to divide the plurality of images into a plurality of areas respectively, and output light intensity, light color, and light direction information for each area.

Meanwhile, the processor may be configured to output the light intensity, the light color, and the light direction information for each area by changing the number of the plurality of areas.

Meanwhile, the image sensor may be configured to output a plurality of images including a plurality of image frames based on a plurality of exposure values by changing an exposure value, wherein the processor calculates the light intensity, based on luminance information in a first image frame and a second image frame among the plurality of image frames.

Meanwhile, the processor may be configured to calculate the light color based on a spectrum in the plurality of images, and calculate the light direction information based on each area in the plurality of images.

Meanwhile, when outputting the light information, the processor may be configured to output a change value of the light information, in response to a plurality of images sequentially output.

Meanwhile, when outputting the light information, the processor may be configured to output a change value in light intensity, a change value in light color, and a change value in light direction, in response to a plurality of images sequentially output.

Meanwhile, the processor may be configured to output the light information including light intensity, light color, and light direction information for object in the plurality of images.

Meanwhile, the processor may be configured to separate an object and a background area in the plurality of images, and output the light information including light intensity, light color, and light direction information for object.

Meanwhile, when outputting the light information, the processor may be configured to separate a background area and an object in the plurality of images, and output a change value in light intensity, a change value in light color, and a change value in light direction with respect to the object, in response to a plurality of images sequentially output.

In another aspect, there is provided an optical capture system comprising a light capture device; and a camera device configured to receive light information from the light capture device.

Meanwhile, the camera device may be configured to calculate an angle or distance to the light capture device, based on an image containing the light capture device, and store the light information, the angle information, or the distance information.

### Effect of the Disclosure

An optical capture device and an optical capture system including the same according to an embodiment of the present disclosure includes a case; a plurality of lens devices disposed in the case, and including two lens devices facing each other; an image sensor configured to convert light that passed through the plurality of lens devices into an electrical signal; and a processor configured to process a plurality of images output from the image sensor, wherein the processor is configured to output light information including light intensity, light color, and light direction information in the plurality of images. Accordingly, it is possible to output light information in all directions.

Meanwhile, the processor may be configured to add the light information to each of the plurality of images and output the plurality of images added to the light information. Accordingly, it is possible to output a plurality of images and light information in all directions.

Meanwhile, the processor may be configured to output an image corresponding to the number of the plurality of lens devices, and the light information including the light intensity, the light color, and the light direction information in the plurality of images. Accordingly, it is possible to output light information in all directions.

Meanwhile, the processor may be configured to output the light information by differentiating a format of the plurality of images and a format of the light information. Accordingly, it is possible to output light information in all directions separately from a plurality of images.

Meanwhile, the processor may be configured to divide the plurality of images into a plurality of areas respectively, and output light intensity, light color, and light direction information for each area. Accordingly, it is possible to output light information in all directions based on a plurality of areas.

Meanwhile, the processor may be configured to output the light intensity, the light color, and the light direction information for each area by changing the number of the plurality of areas. Accordingly, it is possible to output light information in all directions based on a plurality of areas.

Meanwhile, the image sensor may be configured to output a plurality of images including a plurality of image frames based on a plurality of exposure values by changing an exposure value, wherein the processor calculates the light intensity, based on luminance information in a first image frame and a second image frame among the plurality of image frames. Accordingly, it is possible to output light intensity information in all directions.

Meanwhile, the processor may be configured to calculate the light color based on a spectrum in the plurality of images, and calculate the light direction information based on each area in the plurality of images. Accordingly, it is possible to output light color information and light direction information in all directions.

Meanwhile, when outputting the light information, the processor may be configured to output a change value of the light information, in response to a plurality of images sequentially output. Accordingly, it is possible to efficiently output light information in all directions.

Meanwhile, when outputting the light information, the processor may be configured to output a change value in light intensity, a change value in light color, and a change value in light direction, in response to a plurality of images sequentially output. Accordingly, it is possible to efficiently output light information in all directions.

Meanwhile, the processor may be configured to output the light information including light intensity, light color, and light direction information for object in the plurality of images. Accordingly, it is possible to output light information in all directions for object.

Meanwhile, the processor may be configured to separate an object and a background area in the plurality of images, and output the light information including light intensity, light color, and light direction information for object. Accordingly, it is possible to output light information in all directions for object.

Meanwhile, when outputting the light information, the processor may be configured to separate a background area and an object in the plurality of images, and output a change value in light intensity, a change value in light color, and a change value in light direction with respect to the object, in response to a plurality of images sequentially output. Accordingly, it is possible to efficiently output light information in all directions.

In another aspect, there is provided an optical capture system comprising a light capture device; and a camera device configured to receive light information from the light capture device.

Meanwhile, the camera device may be configured to calculate an angle or distance to the light capture device, based on an image containing the light capture device, and store the light information, the angle information, or the distance information. Accordingly, it is possible to synthesize an image close to a live action image based on light information in all directions and a photographed image.

### BRIEF DESCRIPTION OF THE DRAWINGS

FIG. 1 is a diagram illustrating a light capture system comprising a light capture device according to an embodiment of the present disclosure;

FIG. 2 is a diagram illustrating an image photographed by the light capture device of FIG. 1;

FIG. 3A is an example of an internal cross-sectional view of the light capture device of FIG. 1;

FIG. 3B is an example of an internal block diagram of the light capture device of FIG. 1;

FIGS. 3C to 3D are diagrams illustrating various examples of information output from the light capture device of FIG. 1;

FIGS. 4A to 8C are diagrams for explaining the operation of the light capture device of FIG. 1; and

FIG. 9 is a diagram illustrating a light capture device according to another embodiment of the present disclosure.

### DETAILED DESCRIPTION

Hereinafter, the present disclosure will be described in more detail with reference to the drawings.

In general, suffixes such as “module” and “unit” may be used to refer to elements or components. Use of such suffixes herein is merely intended to facilitate description of the specification, and the suffixes do not have any special meaning or function. Accordingly, the terms “module” and “unit” may be used interchangeably.

A light capture device according to an embodiment of the present disclosure can be employed in a terminal. For example, the terminal may be a light capture device such as smartphone, a robot, a robot vacuum cleaner, a drone, a vehicle, etc.

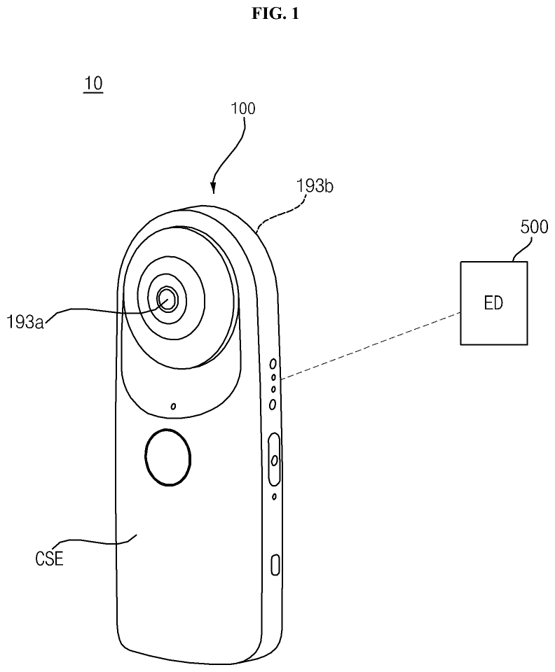

FIG. 1 is a diagram illustrating a light capture system comprising a light capture device according to an embodiment of the present disclosure.

Referring to FIG. 1, a light capture system 10 according to an embodiment of the present disclosure may include a light capture device 100 and a camera device 500 that receives light information from the light capture device 100.

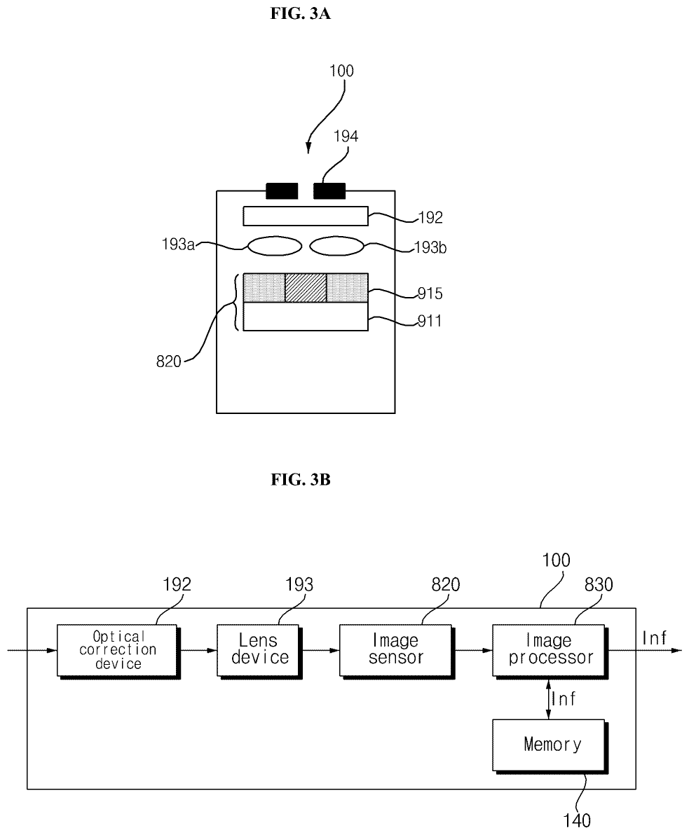

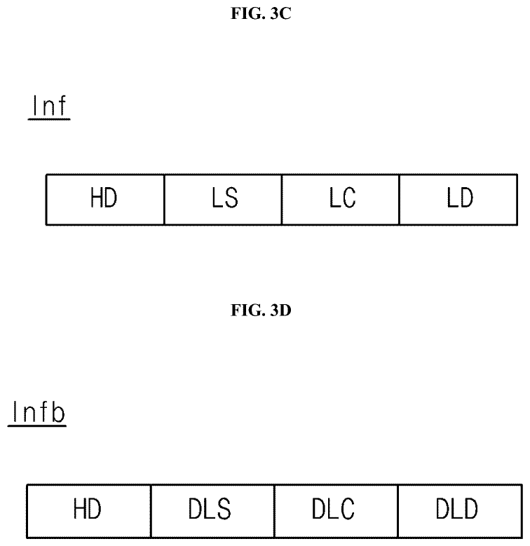

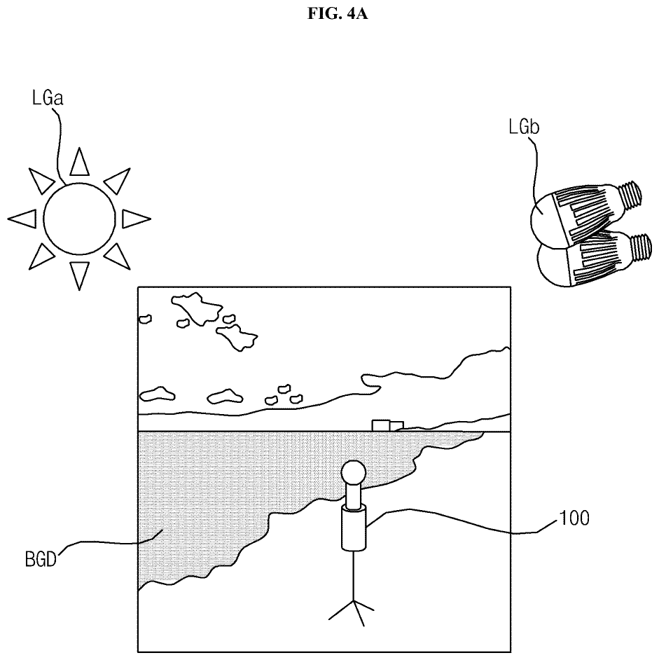

The light capture device 100 according to an embodiment of the present disclosure includes a case CSE, a plurality of lens devices 193 which are disposed in the case CSE and have two lens devices 193a and 193b facing each other, an image sensor (820 in FIG. 3B) which converts the light passing through the plurality of lens devices 193 into electrical signals, and a processor (830 in FIG. 3B) configured to process a plurality of images output from the image sensor 820.

Meanwhile, the processor (830 in FIG. 3B) outputs light information including light intensity, light color, and light direction information in a plurality of images. Accordingly, it is possible to output light information in all directions.

In the drawing, it is illustrated that a first lens device 193a is disposed in a first direction (left direction) of a sphere-shaped case that is a part of the case CSE, and a second lens device 193a is disposed in a second direction (right direction) of a sphere-shaped case.

Since the first lens device 193a and the second lens device 193b are disposed in the first and second directions, which are opposite directions, respectively, it is possible to photograph image in all directions of 360 degrees, and to generate and output light information in all directions.

In particular, since the first lens device 193a and the second lens device 193b are disposed to be opposite to each other, instead of image photographing and light information generation in a 180-degree direction, image photographing and light information generation in a 360-degree direction exceeding 180 degrees become possible.

Meanwhile, the camera device 500 receives light information from the light capture device 100. For example, the camera device 500 may receive light information from the light capture device 100, based on a wireless connection or a wired connection.

At this time, the camera device 500 may only receive light information from the light capture device 100.

Alternatively, the camera device 500 may also receive light information synchronized with the image photographed from the light capture device 100.

Meanwhile, the camera device 500 may photograph the light capture device 100, calculate an angle or distance to the light capture device 100 based on an image including the light capture device 100, and store light information, angle information or distance information. Accordingly, it is possible to synthesize an image close to a live action image based on light information in all directions and the photographed image.

Meanwhile, although not shown in the drawing, the light capture device 100 may be equipped with at least one microphone (not shown) for sound collection, for video shooting, etc.

For example, similar to the first lens device 193a and the second lens device 193b, a first microphone (not shown) and a second microphone (not shown) may be disposed in opposite directions, so that sound acquisition in a 360-degree direction can be performed.

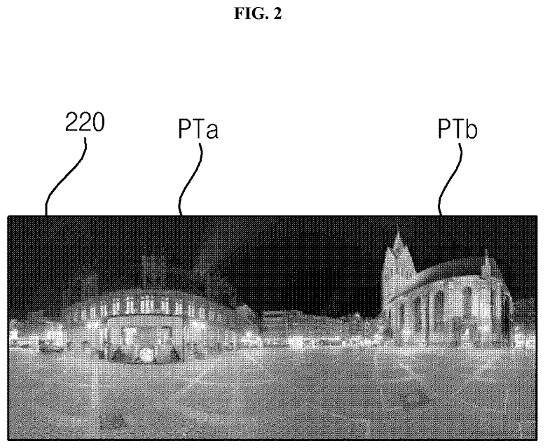

FIG. 2 is a diagram illustrating an image photographed by the light capture device of FIG. 1.

Referring to FIG. 2, the light capture device 100 according to an embodiment of the present disclosure generates an image PTa in a first direction based on light incident through the first lens device 193a, and generates an image Ptb in a second direction based on light incident through the second lens device 193b.

Specifically, the image sensor 820 in the light capture device 100 may generate an image PTa in a first direction by converting light incident through the first lens device 193a into an electrical signal, and generate an image Ptb in a second direction by converting light incident through the second lens device 193b into an electrical signal. Accordingly, it is possible to generate an image in a 360-degree direction exceeding 180 degrees.

FIG. 2 illustrates an image 220 in which the image PTa in a first direction and the image Ptb in a second direction are connected in a horizontal direction, but various modifications are possible.

FIG. 3A is an example of an internal cross-sectional view of the light capture device of FIG. 1.

Referring to FIG. 3A, the light capture device 100 may include an aperture 194, an optical correction device 192, a plurality of lens devices 193a and 193b, and an image sensor 820.

The aperture 194 may open and close the light incident on the plurality of lens devices 193a and 193b.

The image sensor 820 may include an RGb filter 915 and a sensor array 911 that converts optical signals into electrical signals, for sensing RGB colors.

Accordingly, the image sensor 820 may sense and output RGB images, respectively.

FIG. 3B is an example of an internal block diagram of the light capture device of FIG. 1.

Referring to FIG. 3B, the light capture device 100 may include an optical correction device 192, a plurality of lens devices 193, an image sensor 820, and an image processor 830.

The optical correction device 192 may be an Optical Image Stabilizer (OIS) device to prevent hand shaking.

Meanwhile, the plurality of lens devices 193 are disposed in the case CSE, and include two lens devices 193a and 193b opposite to each other.

Meanwhile, the plurality of lens devices 193 may collect light in a 360-degree direction, and transmit it to the image processor 830.

For example, the first lens device 193a may collect light in a direction of approximately 180 degrees in a first direction and transmits it to the image processor 830, and the second lens device 193b may collect light in a direction of approximately 180 degrees in a second direction opposite to the first direction and transmit it to the image processor 830.

Accordingly, light in a direction of approximately 360 degrees may be collected through the first lens device 193a and the second lens device 193b that are opposite to each other and transmitted to the image processor 830.

The image sensor 820 may convert light passing through the plurality of lens devices 193 into electrical signals to generate an RGB image.

For example, the image sensor 820 may generate an image PTa in the first direction by converting light incident through the first lens device 193a into an electrical signal to, and generate an image Ptb in the second direction by converting light incident through the second lens device 193b into an electrical signal. Accordingly, it is possible to generate an image in a 360-degree direction exceeding 180 degrees.

Meanwhile, the image sensor 820 may have a variable exposure value or a variable exposure time, based on an electrical signal.

For example, the image sensor 820 may generate a dark image frame when the exposure value or exposure time is small, and may generate a bright image frame when the exposure value or exposure time is large.

Meanwhile, the processor 830 may process a plurality of images output from the image sensor 820.

Then, the processor 830 may output light information (Inf) including light intensity, light color, and light direction information in a plurality of images.

For example, the processor 830 may output light information (Inf) including each of the light intensity, light color, and light direction information in the image PTa in the first direction and the image Ptb in the second direction output from the image sensor 820. Accordingly, it is possible to output light information in all directions.

Meanwhile, the processor 830 may add light information (Inf) to each of a plurality of images and output it. Accordingly, it is possible to output a plurality of images and light information in all directions.

Meanwhile, the processor 830 may output an image corresponding to the number of the plurality of lens devices 193 and light information Inf including light intensity, light color, and light direction information in the image. Accordingly, it is possible to output light information in all directions.

Meanwhile, the processor 830 may output light information Inf by differentiating the format of the plurality of images and the format of the light information. Accordingly, it is possible to output light information in all directions separately from the plurality of images.

Meanwhile, the processor 830 may calculate the light color based on a spectrum in a plurality of images, and calculate light direction information based on each area in the plurality of images. Accordingly, color information of light in all directions and light direction information may be output.

Meanwhile, when outputting light information, the processor 830 may output a change value (Infb) of light information in response to a plurality of images sequentially output. Accordingly, it is possible to efficiently output light information in all directions.

Meanwhile, when outputting light information, the processor 830 may output a change value in the light intensity, a change value in the light color, and a change value in the light direction, in response to a plurality of images sequentially output. Accordingly, it is possible to efficiently output light information in all directions.

Meanwhile, the processor 830 may output light information (Inf) including light intensity, light color, and light direction information for object in a plurality of images. Accordingly, it is possible to output light information in all directions for object.

Meanwhile, the processor 830 may separate a background area and an object in a plurality of images, and output light information Inf including the light intensity, light color, and light direction information for object. Accordingly, it is possible to output light information in all directions for object.

Meanwhile, when outputting light information, the processor 830 may separate the background area and the object in the plurality of images, in response to the plurality of images sequentially output, and output the change value of light intensity for object, the change value of light color, and the change value of the light direction. Accordingly, it is possible to efficiently output light information in all directions.

Meanwhile, the processor 830 may vary the number of a plurality of areas, and output information on light intensity, light color, and light direction for each area.

Meanwhile, the processor 830 may output a control signal for controlling the optical correction device 192.

Meanwhile, the light capture device 100 may further include a memory 140 that stores light information including light intensity, light color, and light direction information in a plurality of images.

The memory 140 may add light information to each of a plurality of images and output it.

Meanwhile, the memory 140 may store an image corresponding to the number of the plurality of lens devices 193 and light information including light intensity, light color, and light direction information in the image.

Meanwhile, the memory 140 may store light information by differentiating the format of a plurality of images and the format of the light information.

Meanwhile, the memory 140 may divide a plurality of images into a plurality of areas, and store light intensity, light color, and light direction information for each area.

Meanwhile, the memory 140 may vary the number of areas and store the light intensity, light color, and light direction information for each area.

FIGS. 3C to 3D are diagrams illustrating various examples of information output from the light capture device of FIG. 1.

First, FIG. 3C is a diagram illustrating an example of light information (Inf) output from a processor.

Referring to FIG. 3C, the light information (Inf) output from the processor 830 may include a header (HD), light intensity information (LS), light color information (LC), and light direction information (LD).

The light information Inf output from the processor 830 may be synchronized with a plurality of images, for example, the image PTa in the first direction and the image Ptb in the second direction, and may include the light intensity information (LS), the light color information (LC), and the light direction information (LD) in the image PTa in the first direction and the image Ptb in the second direction.

Meanwhile, the processor 830 may output a plurality of images, in response to the number of the plurality of lens devices 193, and may output the light intensity information (LS), the light color information (LC), and the light direction information (LD), in response to the number of the plurality of images.

Meanwhile, the processor 830 may output light information by differentiating the format of the plurality of images and the format of the light information. Accordingly, it is possible to independently output light information (Inf).

Meanwhile, the processor 830 may divide the plurality of images into a plurality of areas, and output light intensity information (LS), light color information (LC), and light direction information (LD) for each area.

Meanwhile, the processor 830 may separate the background area and the object in the plurality of images, and output light intensity information (LS), light color information (LC), and light direction information (LD) for the object.

Meanwhile, the processor 830 may calculate the light color based on the light spectrum or color spectrum in the plurality of images, and calculate light direction information based on each area in the plurality of images.

Next, FIG. 3D is a diagram showing an example of a change value (Infb) of light information output from the processor.

When outputting light information, the processor 830 may output a change value (Infb) of light information in response to a plurality of images sequentially output.

Referring to FIG. 3D, the change value (Infb) of light information output from the processor 830 may include the header (HD), the change value of light intensity (DS), the change value of light color (DC), and the change value of light direction (DD).

The change value (Infb) of the light information output from the processor 830 may be synchronized with a plurality of images, for example, the image PTa in the first direction and the image Ptb in the second direction, and may include a light intensity change value (DS), a light color change value (DC), and a light direction change value (DD) in each of the image PTa in the first direction and the image Ptb in the second direction.

Meanwhile, the processor 830 may output a plurality of images in response to the number of the plurality of lens devices 193, and may output the light intensity change value (DS), the light color change value (DC), and the light direction change value (DD), in response to the number of the plurality of images.

Meanwhile, the processor 830 may output the change value (Infb) of light information by differentiating the format of the plurality of images and the format of the change value (Infb) of light information. Accordingly, it is possible to independently output the change value (Infb) of light information.

Meanwhile, the processor 830 may divide the plurality of images into a plurality of areas, and output the light intensity change value (DS), the light color change value (DC), and the light direction change value (DD) for each area.

Meanwhile, the processor 830 separates the background area and the object in the plurality of images, and output the light intensity change value (DS), the light color change value (DC), and the light direction change value (DD) for object.

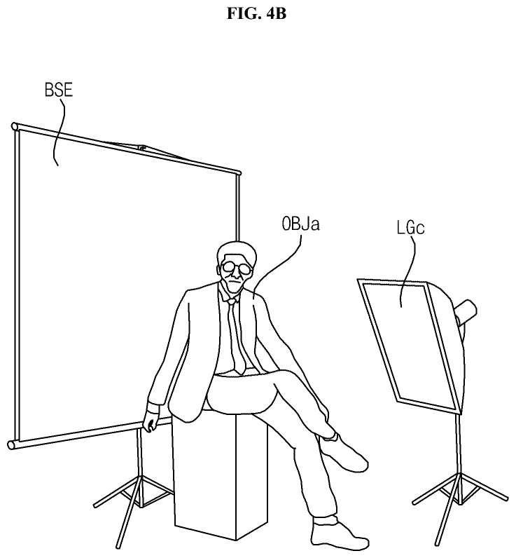

FIGS. 4A to 8C are diagrams for explaining the operation of the light capture device of FIG. 1.

First, FIG. 4A is a diagram illustrating light capture by the light capture device 100 according to an embodiment of the present disclosure.

Referring to FIG. 4A, when the light capture device 100 is disposed in a certain space (BGD), it may capture light from the sun (LGa) which is natural lighting, and light from the lighting device (LGb).

In particular, the light capture device 100 captures light in all directions of 360 degrees, and outputs light information including light intensity, light color, and light direction information based on the captured light or captured image. Accordingly, it is possible to easily obtain light information in all directions by using a single light capture device 100.

FIG. 4B illustrates photographing a person (OBJa) in front of a blue screen (BSE) in a studio by using the camera device 500.

Referring to FIG. 4B, when photographing a person (PBJa) by using the camera device 500, a lighting device (LGc) may be used.

Meanwhile, light information by the lighting device LGc may be calculated based on light information output from the light capture device 100 in FIG. 4A.

Therefore, based on the light information in FIG. 4A and the image photographed using the camera device 500 in FIG. 4B, blue screen photographing and background image may be synthesized. In particular, when background image and person image are synthesized, light information may be used, thereby synthesizing an image close to live-action image.

Therefore, it is possible to overcome the shortcomings of time and space constraints when photographing image, etc. Furthermore, it becomes possible to photograph images that would otherwise be impossible to create with actual subjects and backgrounds. Additionally, it will be possible to reduce actors' appearance fees.

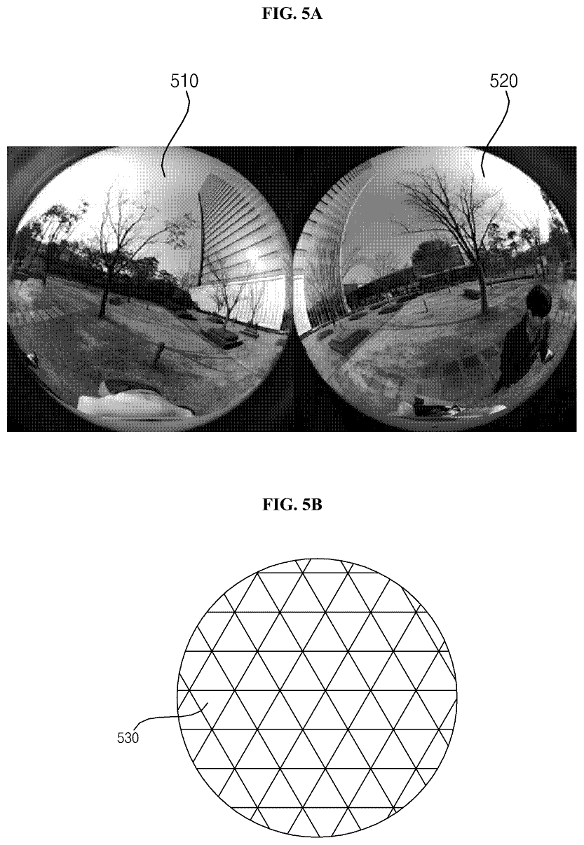

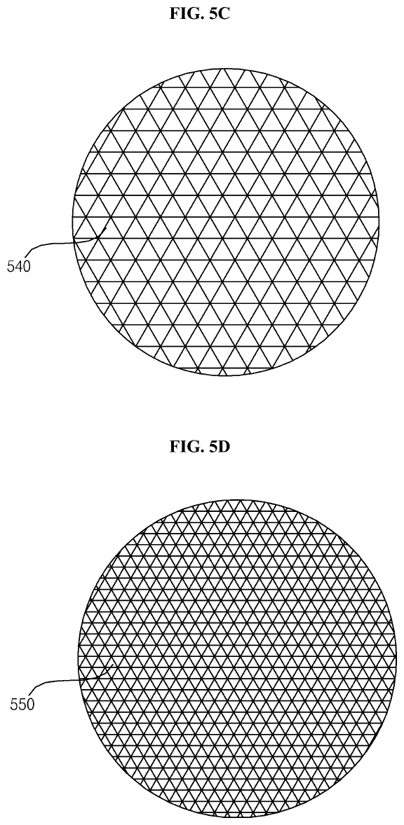

FIG. 5A illustrates a first image 510 generated based on the first lens device 193a and a second image 520 generated based on the second lens device 193b.

Referring to FIG. 5A, when the first lens device 193a and the second lens device 193b have a circular or spherical shape, circular first image 510 and second image 520 may be obtained as shown in FIG. 5A.

At this time, the first image 510 may be an image in a first direction, and the second image 520 may be an image in a second direction opposite to the first direction.

Meanwhile, the processor 830 may divide a plurality of images into a plurality of areas, and output light intensity, light color, and light direction information for each area.

FIG. 5B illustrates an example of dividing the first image 510 or the second image 520 of FIG. 5A into a plurality of areas 530.

Referring to FIG. 5B, when the image 510 or the second image 520 is divided into 100 polygon areas, the processor 830 may output light intensity, light color, and light direction information for each area.

FIG. 5C illustrates another example of dividing the first image 510 or the second image 520 of FIG. 5A into a plurality of areas 540.

Referring to FIG. 5C, when the first image 510 or the second image 520 is divided into 420 polygon areas, the processor 830 may output light intensity, light color, and light direction information for each area.

FIG. 5D illustrates another example of dividing the first image 510 or the second image 520 of FIG. 5A into a plurality of areas 550.

Referring to FIG. 5D, when the first image 510 or the second image 520 is divided into 1,700 polygon areas, the processor 830 may output light intensity, light color, and light direction information for each area.

As the number of each area in the first image 510 or the second image 520 increases as it progresses from FIG. 5B to FIG. 5D, the light intensity, light color, and light direction information may be output in more detail for each area.

Meanwhile, referring to FIGS. 5B to 5D, the processor 830 may calculate the light color based on the light spectrum or color spectrum in a plurality of images, and calculate light direction information based on each area in the plurality of images.

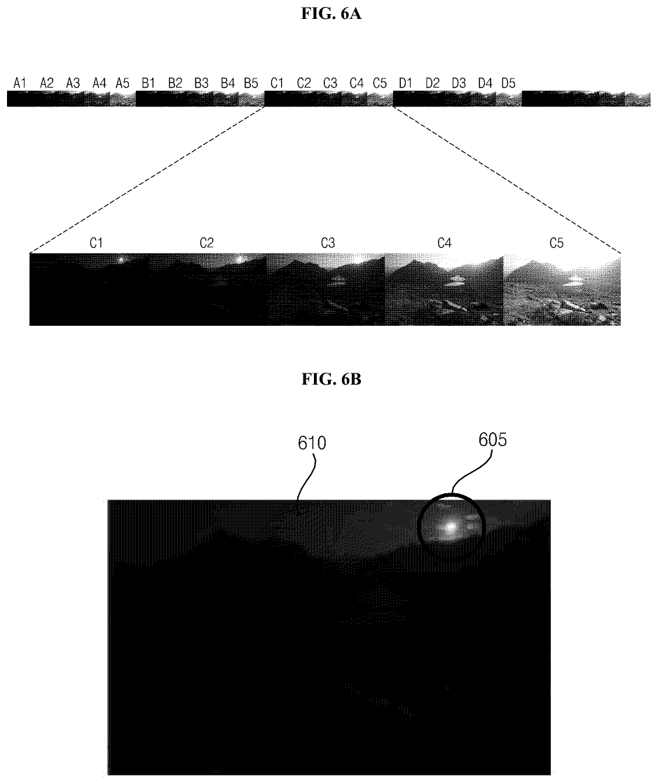

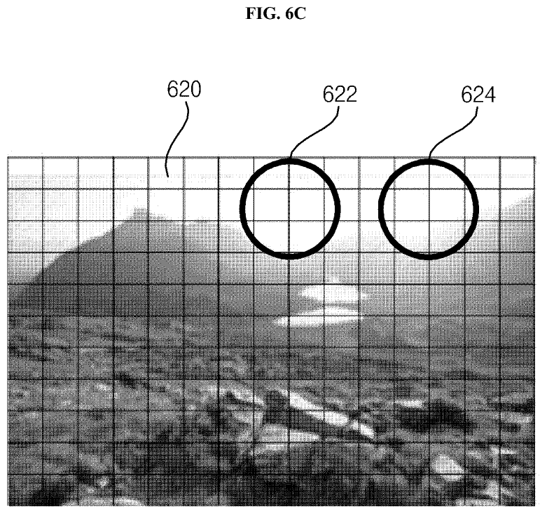

FIG. 6A illustrates outputting a plurality of image frames (A1 to A5, B1 to B5, C1 to C5, and D1 to D5) from the image sensor 820.

Referring to FIG. 6A, the image sensor 820 may vary the exposure value, and output a plurality of images including a plurality of image frames based on the plurality of exposure values.

For example, among the plurality of images, the first image may have a plurality of image frames A1 to A5, the second image may have a plurality of image frames B1 to B5, the third image may have a plurality of image frames C1 to C5, and the fourth image may have a plurality of image frames D1 to D5.

Meanwhile, the image sensor 820 may vary the exposure value, and output a plurality of images (A, B, C, D) including a plurality of image frames based on a plurality of exposure values.

As shown in FIG. 6A, the image sensor 820 may gradually increase the exposure value, and sequentially output from a dark image frame A to a bright image frame A5.

In FIG. 6A, a third image C is selected from among a plurality of images, and some of the plurality of image frames C1 to C5 in the third image C are selected.

FIG. 6B illustrates that the darkest image frame C1 in the third image C is selected as a first image frame 610, and FIG. 6C illustrates that the brightest image frame C5 in the third image C is selected as a second image frame 620.

Referring to FIG. 6B, the processor 830 may calculate the light intensity, based on luminance information in the first image frame 610 and the second image frame 620 among the plurality of image frames A1 to A5, B1 to B5, C1 to C5, and D1 to D5.

For example, the processor 830 may extract luminance information based on a first area 605 in the first image frame 610, extract luminance information based on a second area 622 in the second image frame 620, and may extract luminance information based on a third area 624.

In addition, the processor 830 may calculate the light intensity, based on the luminance information of each area 605, 622, and 624.

At this time, the processor 830 may calculate the light intensity, based on the luminance information of each area 605, 622, and 624 and the varied exposure value.

Meanwhile, the processor 830 may calculate that the second area 622 and the third area 624 in the second image frame 620 have a different light intensity according to a different exposure value weight, even though they have the same luminance information.

Meanwhile, the exposure value weight may be set based on the exposure value from the previous frame and luminance information.

For example, the exposure value weight may vary when luminance information varies, and may vary when the exposure value from the previous frame varies.

Meanwhile, the processor 830 may calculate the light color based on the light spectrum or color spectrum in the plurality of images, and calculate light direction information based on each area in the plurality of images.

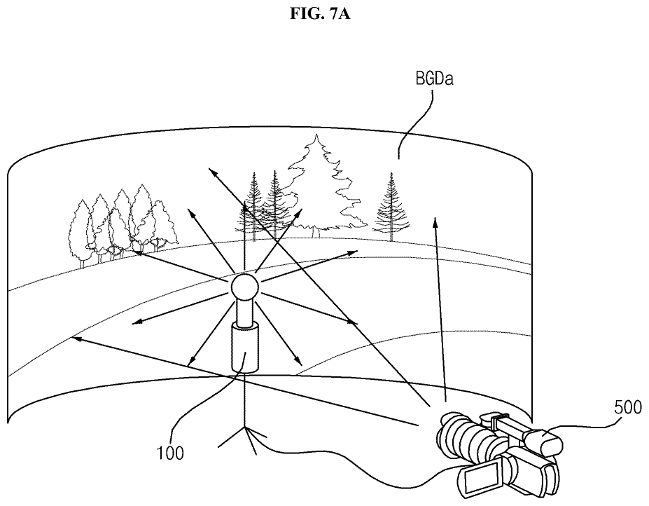

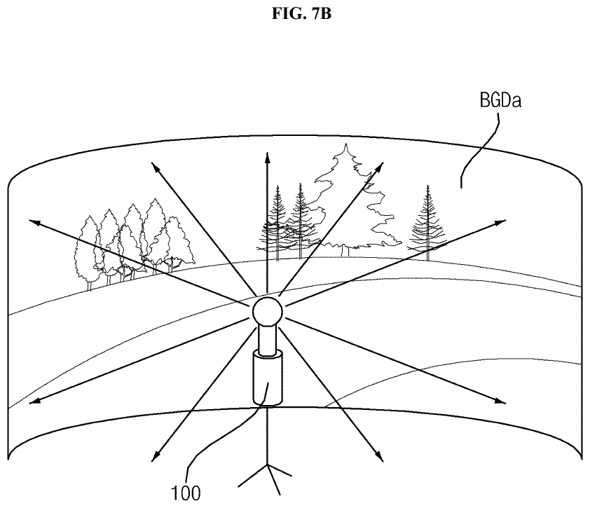

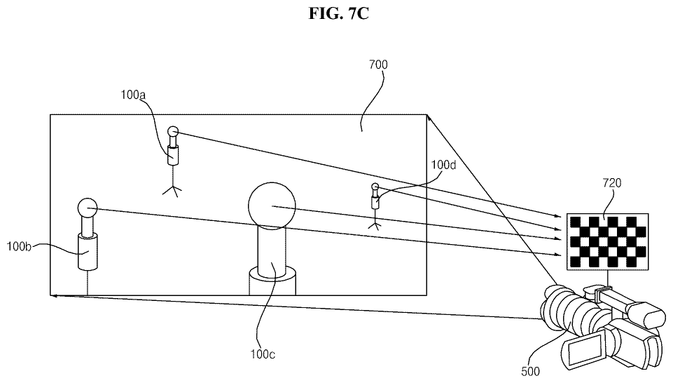

FIG. 7A is a diagram illustrating a passive capture mode using a light capture device.

Referring to FIG. 7A, in the passive capture mode, the light capture device 100 may become a subject and be photographed by the camera device 500.

Meanwhile, the light capture device 100 transmits light information including light intensity, light color, and light direction information in the located space BGDa to the camera device 500.

The camera device 500 receives light information from the light capture device 100, calculates an angle or distance to the light capture device 100 based on the image including the light capture device 100, and stores light information, angle information or distance information.

In addition, the camera device 500 may reproduce light or illumination to target the angle of view and view point toward which the camera device 500 is facing, based on the light information, the angle information, or the distance information.

Therefore, based on the light information of the light capture device 100 and the image captured using the camera device 500, a blue screen photographing and a background image may be synthesized. Particularly, when a background image and a person image are synthesized, light information may be utilized, thereby synthesizing an image that is close to live-action image.

Therefore, it is possible to overcome the shortcomings of time and space constraints when photographing an image, etc. Furthermore, it becomes possible to photograph an image that would otherwise be impossible to create with actual subjects and backgrounds.

FIG. 7B is a diagram illustrating an active capture mode using a light capture device.

Referring to FIG. 7B, in the active capture mode, the light capture device 100 may output light information including light intensity, light color, and light direction information in a located space BGDa, and a photographed image.

Since the light capture device 100 further outputs an RGB image in addition to light information, a blue screen photographing and a background image may be synthesized, based on light information and a photographed image. Particularly, when a background image and a person image are synthesized, light information may be utilized, thereby synthesizing an image that is close to live-action image.

Therefore, it is possible to overcome the shortcomings of time and space constraints when photographing an image, etc. Furthermore, it becomes possible to photograph an image that would otherwise be impossible to create with actual subjects and backgrounds.

FIG. 7C is a diagram illustrating another example of an active capture mode using a light capture device.

Referring to FIG. 7C, a plurality of light capture devices 100a to 100d transmit light information including light intensity, light color, and light direction information in the located space BGDa to the camera device 500, respectively.

Meanwhile, by attaching a pattern board 720 to the upper portion of the camera device 500, the camera pose may be calculated.

The camera device 500 receives light information from a plurality of light capture devices 100a to 100d, calculates an angle or distance to the plurality of light capture devices 100a to 100d, respectively, based on the image including the plurality of light capture devices 100a to 100d, and stores light information, angle information, or distance information.

Meanwhile, the camera device 500 may perform an angle or distance calculation for the plurality of light capture devices 100a to 100d using trigonometry or the like.

In addition, the camera device 500 may reproduce light or illumination to target the angle of view and view point toward which the camera device 500 is facing, based on light information, angle information, or distance information.

Therefore, based on the light information of the light capture device 100 and the image captured using the camera device 500, a blue screen photographing and a background image may be synthesized. Particularly, when a background image and a person image are synthesized, light information may be utilized, thereby synthesizing an image that is close to live-action image.

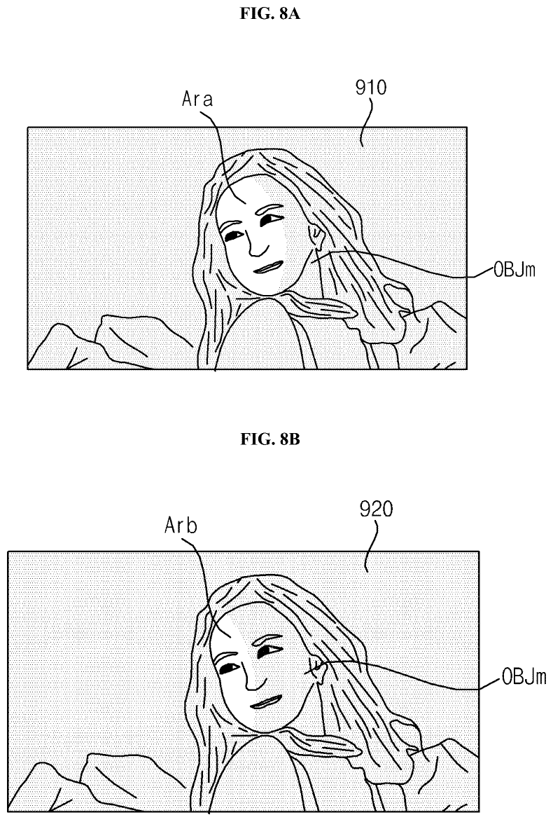

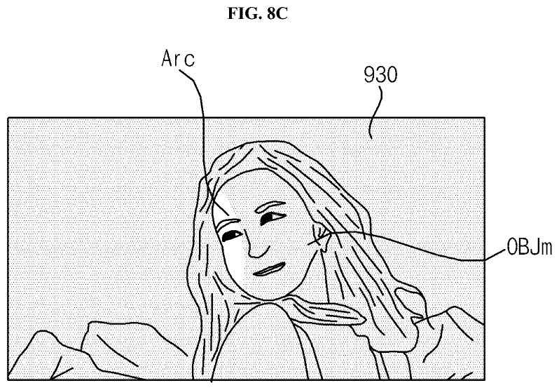

FIGS. 8A to 8C are diagrams illustrating various examples of synthetic images by using the light capture device 100.

When information on light that moves sequentially is output from the light capture device 100, the camera device 500, etc. synthesizes the light information with an image including a person OBJm to generate a synthetic image 910.

FIG. 8A illustrates a synthetic image 910 in which light information at a first position is synthesized with an image including a person OBJm, at a first time point.

FIG. 8A illustrates that light or illumination is illuminated on most area Ara of the face of a person OBJm.

FIG. 8B illustrates a synthetic image 920 in which light information of a second position moved to the left from the first position is synthesized with an image including a person OBJm, at a second time point after the first time point.

FIG. 8B illustrates that light or illumination is illuminated on the left half area Arb of the face of a person OBJm.

FIG. 8C illustrates a synthetic image 930 in which light information of a third position moved to the left of the second position is synthesized with an image including a person OBJm, at a third time point after the second time point.

FIG. 8C illustrates that light or illumination is illuminated on a partial area Arc on the left side of the face of a person OBJm.

Referring to FIGS. 8A to 8C, when the light information is output from the light capture device 100 as moving sequentially, the camera device 500, etc. synthesizes the light information with the image including a person OBJm, thereby simply creating a synthetic image. In particular, it is possible to generate a synthetic image that is close to a live action image.

Such a synthetic image, etc may be used to create a natural image that is close to a live action image. Alternatively, when producing metaverse images, etc., it is possible to provide natural 3D rendering and texture by using light information acquired from live action.

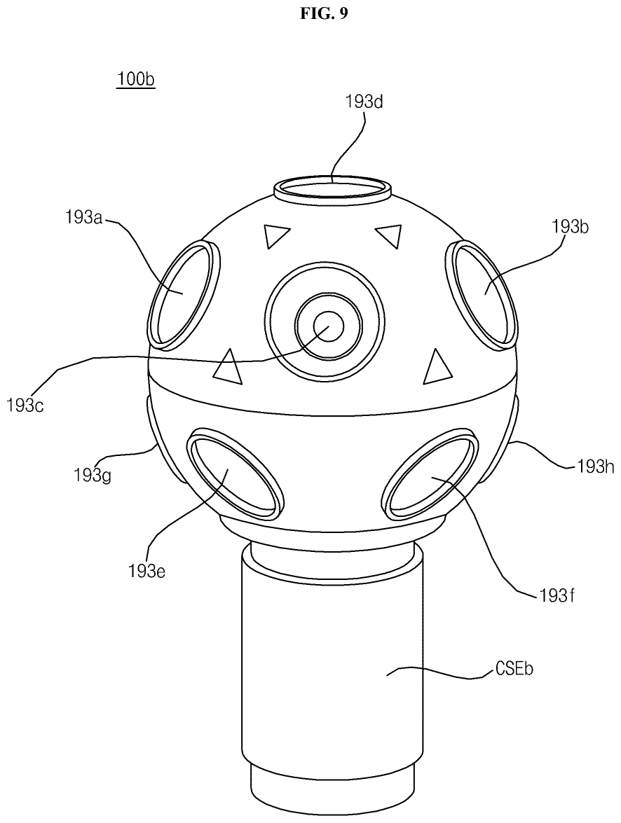

FIG. 9 is a diagram illustrating a light capture device according to another embodiment of the present disclosure.

Referring to FIG. 9, a light capture device 100b according to another embodiment of the present disclosure includes a case CSEb, a plurality of lens devices 193a to 193g that is disposed in the case CSEb, and includes two lens devices 193a and 193b that are opposite to each other, an image sensor (820 in FIG. 3B) that converts light passing through a plurality of lens devices 193a to 193g into an electrical signal, and a processor (830 in FIG. 3B) that processes signals from a plurality of images output from the image sensor 820.

Meanwhile, the processor (830 in FIG. 3B) outputs light information including light intensity, light color, and light direction information in a plurality of images. Accordingly, it is possible to output light information in all directions.

FIG. 9 illustrates that the first lens device 193a is disposed in a first direction (left direction) of sphere-shaped case that is part of the case CSEb, and the second lens device 193b is disposed in a second direction (right direction) of sphere-shaped case.

Since the first lens device 193a and the second lens device 193b are respectively disposed in the first direction and the second direction which are opposite to each other, it is possible to photograph images in all directions of 360 degrees, and it becomes possible to generate and output light information in all directions of 360 degrees.

In particular, since the first lens device 193a and the second lens device 193b are disposed to be opposite to each other, it is possible to photograph images in a 360-degree direction exceeding 180 degrees and generate light information, instead of photographing images in a 180-degree direction and generating light information.

Meanwhile, although not shown in the drawing, the light capture device 100b may be equipped with at least one microphone (not shown) for sound collection, for image photographing, etc.

For example, similar to the first lens device 193a and the second lens device 193b, a first microphone (not shown) and a second microphone (not shown) are disposed in opposite directions to perform sound collection in 360 degrees.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

1. A light capture device comprising:
a case;
a plurality of lens devices disposed in the case, and including two lens devices facing each other;
an image sensor configured to convert light that passed through the plurality of lens devices into an electrical signal; and
a processor configured to process a plurality of images output from the image sensor,
wherein the processor is configured to output light information including light intensity, light color, and light direction information in the plurality of images.

2. The light capture device of claim 1, wherein the processor is configured to add the light information to each of the plurality of images and output the plurality of images added to the light information.

3. The light capture device of claim 1, wherein the processor is configured to output an image corresponding to the number of the plurality of lens devices, and the light information including the light intensity, the light color, and the light direction information in the plurality of images.

4. The light capture device of claim 1, wherein the processor is configured to output the light information by differentiating a format of the plurality of images and a format of the light information.

5. The light capture device of claim 1, wherein the processor is configured to divide the plurality of images into a plurality of areas respectively, and output light intensity, light color, and light direction information for each area.

6. The light capture device of claim 5, wherein the processor is configured to output the light intensity, the light color, and the light direction information for each area by changing the number of the plurality of areas.

7. The light capture device of claim 1, wherein the image sensor is configured to output a plurality of images including a plurality of image frames based on a plurality of exposure values by changing an exposure value,
wherein the processor calculates the light intensity, based on luminance information in a first image frame and a second image frame among the plurality of image frames.

8. The light capture device of claim 1, wherein the processor is configured to calculate the light color based on a spectrum in the plurality of images, and calculate the light direction information based on each area in the plurality of images.

9. The light capture device of claim 1, wherein when outputting the light information, the processor is configured to output a change value of the light information, in response to a plurality of images sequentially output.

10. The light capture device of claim 1, wherein when outputting the light information, the processor is configured to output a change value in light intensity, a change value in light color, and a change value in light direction, in response to a plurality of images sequentially output.

11. The light capture device of claim 1, wherein the processor is configured to output the light information including light intensity, light color, and light direction information for object in the plurality of images.

12. The light capture device of claim 1, wherein the processor is configured to separate an object and a background area in the plurality of images, and output the light information including light intensity, light color, and light direction information for object.

13. The light capture device of claim 1, wherein when outputting the light information, the processor is configured to separate a background area and an object in the plurality of images, and output a change value in light intensity, a change value in light color, and a change value in light direction with respect to the object, in response to a plurality of images sequentially output.

14. A light capture system comprising:
a light capture device; and
a camera device configured to receive light information from the light capture device,
wherein the light capture device comprises:
a case;
a plurality of lens devices disposed in the case, and including two lens devices facing each other;
an image sensor configured to convert light that passed through the plurality of lens devices into an electrical signal; and
a processor configured to process a plurality of images output from the image sensor,
wherein the processor is configured to output light information including light intensity, light color, and light direction information in the plurality of images.

15. The light capture system of claim 14, wherein the camera device is configured to calculate an angle or distance to the light capture device, based on an image containing the light capture device, and store the light information, the angle information, or the distance information.

16. The light capture system of claim 14, wherein the processor is configured to output an image corresponding to the number of the plurality of lens devices, and the light information including the light intensity, the light color, and the light direction information in the plurality of images.

17. The light capture system of claim 14, wherein the processor is configured to output the light information by differentiating a format of the plurality of images and a format of the light information.

18. The light capture system of claim 14, wherein the processor is configured to divide the plurality of images into a plurality of areas respectively, and output light intensity, light color, and light direction information for each area.

19. The light capture system of claim 14, wherein the image sensor is configured to output a plurality of images including a plurality of image frames based on a plurality of exposure values by changing an exposure value,
wherein the processor calculates the light intensity, based on luminance information in a first image frame and a second image frame among the plurality of image frames.

20. The light capture system of claim 14, wherein when outputting the light information, the processor is configured to separate a background area and an object in the plurality of images, and output a change value in light intensity, a change value in light color, and a change value in light direction with respect to the object, in response to a plurality of images sequentially output.
